(19) United States
(12) Patent Application Publication
(10) Pub. No.: US 2011/0173376 A1
(43) Pub. Date: Jul. 14, 2011

(54) CACHE APPARATUS FOR INCREASING DATA ACCESSING SPEED OF STORAGE DEVICE

(76) Inventors: Kuo-Hua Yuan, Kaohsiung City (TW); Chao-Nan Chen, Taipei City (TW)

(21) Appl. No.: 12/720,678

(22) Filed: Mar. 10, 2010

(30) Foreign Application Priority Data
Jan. 14, 2010 (TW) 099100910

(51) Int. Cl. G06F 12/00; G06F 12/02; G06F 12/08

(52) U.S. Cl. 711/103; 711/113; 711/E12.001; 711/E12.008; 711/E12.019

(57) ABSTRACT

A cache apparatus for increasing data accessing speed of a storage device includes: a non-volatile memory, for storing data; a memory controller, coupled to the non-volatile memory, for controlling data accessing operations of the non-volatile memory; a first transmission interface, coupled to the memory controller, for electrically connecting the memory controller to the storage device; and a second transmission interface, coupled to the memory controller, for electrically connecting the memory controller to a user-end personal computer.

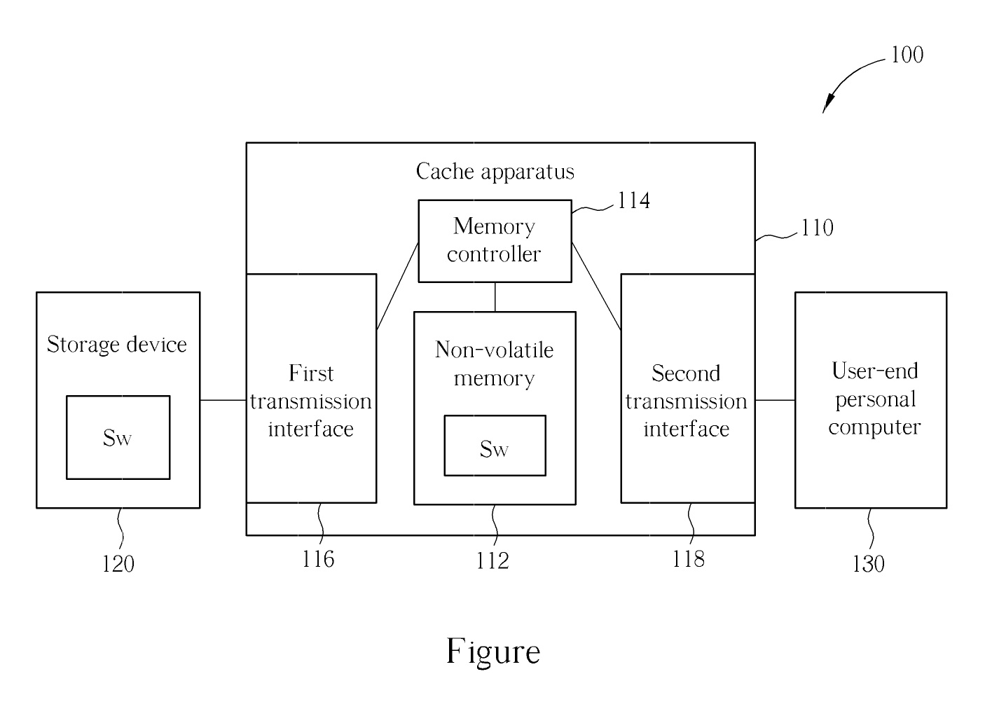

### BACKGROUND OF THE INVENTION

1. Field of the Invention

The present invention relates to a data cache mechanism, and more particularly, to a cache apparatus for increasing data accessing speed of a storage device.

2. Description of the Prior Art

In modern information society, the flow of information is increased greatly and becoming part of everyday life. In order to manage all of the information conveniently and quickly, the memory devices used for information accessing have become an important development issue in the information technology (IT) industry. The advantages of a NAND flash memory include low power consumption, high accessing speed, data read/write capability, non-volatile storage, and no mechanical motions. Therefore, the NAND flash memory is widely used in various storage devices.

Generally, the NAND flash memory is a non-volatile memory, and has the advantages of recordable, rewritable and electrical erasable characteristics, and the data stored in the NAND flash memory will not be lost or damaged due to the accidental loss of electric power. Therefore, the non-volatile NAND flash memory is one of the most popular storage devices in the field of portable electronic devices or embedded electronic systems. For example, a personal digital assistant (PDA), a digital camera, an MP3 walkman, and a recorder device are all installed with a NAND flash memory.

The traditional mechanical hard disk drive (HDD) usually utilizes dynamic random access memory (DRAM) as its built-in cache memory. DRAM is a type of random access memory that stores each bit of data in a separate capacitor within an integrated circuit by controlling the number of charges stored in the capacitor. Since real capacitors leak charge, the information eventually fades unless the capacitor is refreshed periodically. Because of this refresh requirement, unlike flash memory, DRAM is a non-volatile memory which loses its stored data when the power supply is cut off. Besides, the traditional mechanical HDD has to move an actuator arm (or access arm) across the platters for data accessing, this motion needs a lot of operation time to retrieve the required data. Therefore, increasing the capacity of the cache memory can significantly reduce data accessing time. However, DRAM has higher manufacturing cost and limited capacity. Thus, there is a need for providing a cache apparatus for increasing data accessing speed of a storage device (e.g., a traditional mechanical HDD) effectively and easily.

### SUMMARY OF THE INVENTION

It is therefore one of the objectives of the present invention to provide a cache apparatus for increasing data accessing speed of a storage device, to solve the above mentioned problems.

According to an embodiment of the present invention, an exemplary cache apparatus for increasing data accessing speed of a storage device is disclosed. The exemplary cache apparatus includes a non-volatile memory, a memory controller, a first transmission interface and a second transmission interface. The non-volatile memory is used for storing data. The memory controller is coupled to the non-volatile memory, and utilized for controlling data accessing operations of the non-volatile memory. The first transmission interface is coupled to the memory controller, and utilized for electrically connecting the memory controller to the storage device. The second transmission interface is coupled to the memory controller, and utilized for electrically connecting the memory controller to a user-end personal computer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGURE illustrates a computer system according to an exemplary embodiment of the present invention.

### DETAILED DESCRIPTION

Certain terms are used throughout the following description and claims to refer to particular components. As one skilled in the art will appreciate, hardware manufacturers may refer to a component by different names. This document does not intend to distinguish between components that differ in name but in function. In the following discussion and in the claims, the terms “include”, “including”, “comprise”, and “comprising” are used in an open-ended fashion, and thus should be interpreted to mean “including, but not limited to . . . ”. The terms “couple” and “coupled” are intended to mean either an indirect or a direct electrical connection. Thus, if a first device couples to a second device, that connection may be through a direct electrical connection, or through an indirect electrical connection via other devices and connections.

Please refer to the accompanying FIGURE which illustrates a computer system 100 according to an exemplary embodiment of the present invention. The computer system 100 includes, but is not limited to, a cache apparatus 110, a storage device 120 and a user-end personal computer 130. Please note that, in this exemplary embodiment of the present invention, the storage device 120 can be a hard disk drive (HDD) or any other kinds of storage units which utilize mechanical means for data accessing, but this should not be a limitation of the present invention. Using other storage device suitable for realizing the cache apparatus 110 of the present invention for increasing data accessing speed also falls within the scope of the present invention. The cache apparatus 110 includes, but is not limited to, a non-volatile memory 112, a memory controller 114, a first transmission interface 116 and a second transmission interface 118. Please note that, in one exemplary embodiment of the present invention, the non-volatile memory 112 can be a NAND flash memory or a memory chipset composed by a plurality of flash memory chips. However, this should not be taken as a limitation of the present invention. Using other non-volatile memory (e.g., Ferro electric RAM) or chipset composed by those non-volatile memories also falls within the scope of the present invention. The non-volatile memory 112 is used for storing data. The memory controller 114 is coupled to the non-volatile memory 112, and utilized for controlling data accessing operations of the non-volatile memory 112. The first transmission interface 116 is coupled to the memory controller 114, and utilized for electrically connecting the memory controller 114 to the storage device 120. The second transmission interface 118 is coupled to the memory controller 114, and utilized for electrically connecting the memory controller 114 to the user-end personal computer 130.

The exemplary embodiment mentioned below takes a hard disk drive serving as the storage device 120 and a NAND flash memory serving as the non-volatile memory 112 as an example, for describing technical features of the present invention clearly. Because the data accessing speed of the non-volatile memory 112 (i.e., NAND flash memory) is much faster than that of the storage device 120 (i.e., hard disk drive). Therefore, the data accessing time of the user-end personal computer 130 can be decreased greatly by utilizing the non-volatile memory 112 to access data or program. However, the storage capacity of the non-volatile memory 112 is much smaller than that of the storage device 120. Therefore, the memory controller 114 of the present invention needs to arrange the data storage locations more effectively, such as stores more frequently used data in the non-volatile memory 112 and stores less frequently used data in the storage device 120. For example, when the memory controller 114 stores a resident program (i.e. the more frequently used data) Sw used for computer booting into the non-volatile memory 112, the user-end personal computer 130 can retrieve the resident program Sw from the non-volatile memory 112 via the memory controller 114 directly, thereby reducing the boot time of the computer 130. In summary, in one exemplary embodiment, the non-volatile memory 112 is used to serve as a cache memory.

Besides, the first transmission interface 116 of the present invention can be a serial advanced technology attachment (SATA) interface or a universal serial bus (USB); similarly, the second transmission interface 118 of the present invention can also be a SATA interface or a USB bus. Therefore, the storage device 120 and the user-end personal computer 130 can be connected to the cache apparatus 110 via a SATA interface or a USB bus.

Please note that, the structure shown in FIGURE is merely used for illustrating the electrical connecting relations between the storage device 120, the cache apparatus 110 and the user-end personal computer 130, and is not to set a limitation to the physical locations of the storage device 120, the cache apparatus 110 and the user-end personal computer 130 in a practical application. For example, if the storage device 120 is an external storage device and disposed outside of the housing of the user-end personal computer 130, the cache apparatus 110 can be implemented in the storage device 120, externally connected between the storage device 120 and the user-end personal computer 130, or installed upon the user-end personal computer 130; on the other hand, if the storage device 120 is an internal storage device and implemented in the same housing of the user-end personal computer 130, the cache apparatus 110 can also be implemented in the same housing of the user-end personal computer 130 (e.g., implemented in the storage device 120 or installed upon the user-end personal computer 130). Certainly, people skilled in the art will readily appreciate that various modifications of the computer system 100 may be made without departing the scope of the present invention.

In summary, the present invention provides a cache apparatus for increasing data accessing speed of a storage device. In one exemplary embodiment, the present invention utilizes a NAND flash memory as a cache memory of a storage device, thereby increasing the data accessing speed of the storage device. In addition, due to the fact that the NAND flash memory is a non-volatile memory, the data stored in the NAND flash memory will not be lost or damaged when the power supply is cut off abnormally.

Those skilled in the art will readily observe that numerous modifications and alterations of the device and method may be made while retaining the teachings of the invention.

What is claimed is:

1. A cache apparatus for increasing data accessing speed of a storage device, comprising:
a non-volatile memory, for storing data;
a memory controller, coupled to the non-volatile memory, for controlling data accessing operations of the non-volatile memory;
a first transmission interface, coupled to the memory controller, for electrically connecting the memory controller to the storage device; and
a second transmission interface, coupled to the memory controller, for electrically connecting the memory controller to a user-end personal computer.

2. The cache apparatus of claim 1, wherein the non-volatile memory is a NAND flash memory.

3. The cache apparatus of claim 1, wherein the storage device is a hard disk drive.

4. The cache apparatus of claim 1, wherein the first transmission interface is a serial advanced technology attachment (SATA) interface.

5. The cache apparatus of claim 1, wherein the second transmission interface is a serial advanced technology attachment (SATA) interface.

6. The cache apparatus of claim 1, wherein the first transmission interface is a universal serial bus (USB).

7. The cache apparatus of claim 1, wherein the second transmission interface is a universal serial bus (USB).
